(19) United States
(12) Patent Application Publication
(10) Pub. No.: US 2002/0144145 A1
(43) Pub. Date: Oct. 3, 2002

(54) Method of activating computer-readable data

(76) Inventors: Richard L. Burtner, Brentwood, TN (US); Donna D. Blevins, Greeneville, TN (US); Justin J. Clark, Coon Rapids, MN (US); James P. Rainey, Johnson City, TN (US); Vinay K. Dheer, Nashville, TN (US)

Correspondence Address: Bryan W. Bockhop, Esq., BOCKHOP & REICH, LLP, Bldg. 400, Suite 300, 3235 Satellite Blvd., Duluth, GA, 30096, US

(21) Appl. No.: 09/818,828

(22) Filed: Mar. 27, 2001

(51) Int. Cl. H04L 9/00

(52) U.S. Cl. 713/201

(57) ABSTRACT

A method of activating computer-readable data from a central server transmits a request data packet via a global computer network from a local computer to a central server. The request data packet includes information that identifies a user and that identifies a specific unit of data that the user desires to activate. The specific unit of data belongs to a predefined plurality of units of data that are stored local to the local computer. A unit-specific activating data packet is received from the central server at the local computer. A routine is executed at the local computer that uses the unit-specific activating data packet to activate the specific unit of data.

### BACKGROUND OF THE INVENTION

1. Field of the Invention

The present invention relates to computer data access and, more specifically a method for facilitating activation of specific data units.

2. Description of the Prior Art

Many current global computer network data transfer applications, such as on-line educational systems, provide access to units of data in exchange for payment. Such payment may be made on a subscription basis, wherein a user has unlimited access to a database, or it may be on a unit basis, wherein a user purchases access to predefined units of data. The data may be transferred to the user in one of several ways. For example, the data may be downloaded via the global computer network or it may be mailed in the form of a CD-ROM.

Certain educational programs include large amounts of data that may be used in constructing lessons. Typically, the user is required to pay for lessons on a per-lesson basis, in which the user pays for a lesson and then the student is allowed access to the lesson via the global computer network. Because many students use only slow net access devices, such as dial-up modems, the lesson may be downloaded to the user, but because of the slow modem speed or large size of data, the download period may be unacceptable. Also, access to on-line lessons may result in interruptions to the student during downloading periods. Such interruptions may be especially disruptive to students with short attention spans.

One solution is to send the lessons to the user via a CD-ROM. However, the sending entity, if it charges on a per-lesson basis, would have to send a different CD-ROM to the user for each lesson. If many lessons are transferred, this method of transferring lessons would be unduly burdensome and wasteful.

Therefore, there is a need for method of transferring data to a user and then remotely activate only predetermined blocks of the data.

### SUMMARY OF THE INVENTION

The disadvantages of the prior art are overcome by the present invention which, in one aspect, is a method of activating computer-readable data from a central server in which a request data packet is transmitted via a global computer network from a local computer to a central server. The request data packet includes information that identifies a user and that identifies a specific unit of data that the user desires to activate. The specific unit of data belongs to a predefined plurality of units of data that are stored local to the local computer. A unit-specific activating data packet is received from the central server at the local computer. A routine is executed at the local computer that uses the unit-specific activating data packet to activate the specific unit of data.

In another aspect of the invention, a request data packet is received at the central server from a local computer via a global computer network. The request data packet includes information that identifies a user and that identifies a specific unit of data that the user desires to activate. The specific unit of data belongs to a predefined plurality of units of data that are stored local to the local computer. A verification routine that determines if the user is authorized to activate the specific unit of data is executed. If the user is authorized to activate the specific unit of data, then a unit-specific activating data packet is transmitted from the central server to the local computer. The activating data packet allows the local computer to activate the specific unit of data.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a block diagram demonstrating computer assets employed in one embodiment of the invention.

FIG. 2 is a block diagram demonstrating communications and actions that occur in one embodiment of the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

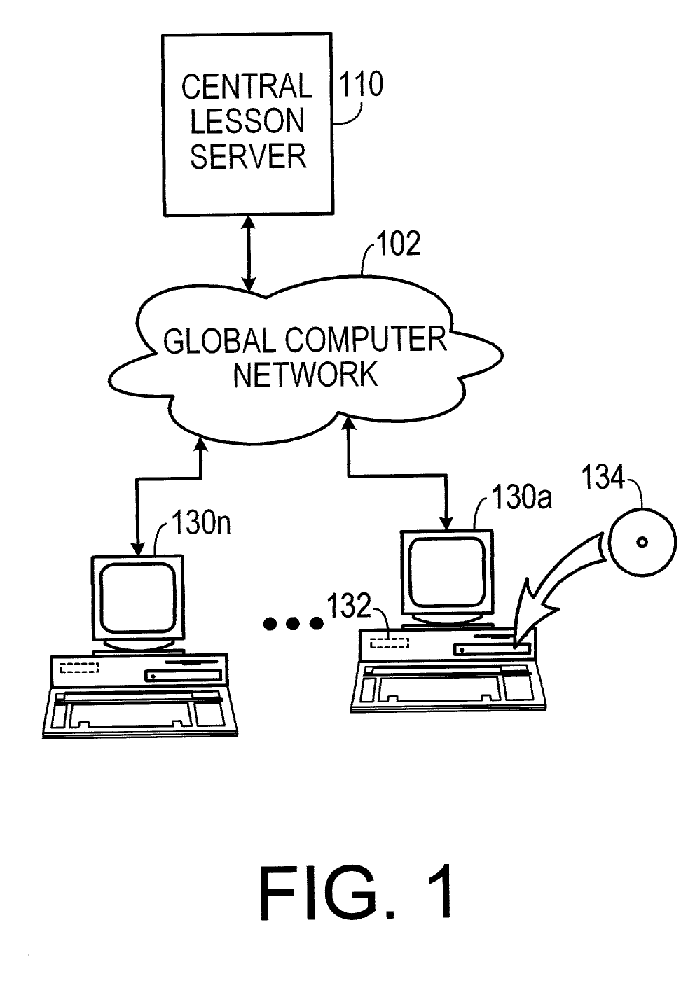

As shown in FIG. 1, in one embodiment of the invention, a central lesson server 110 communicates with a plurality of local computers 130a-n via the global computer network 102 (such as the Internet). Each local computer 130a-n includes a non-volatile storage mechanism, such as a hard-drive 132 or a CD-ROM reader that is capable of reading a CD-ROM 134. A plurality of lessons are transferred to a local computer either in one large download or a mailing of a CD-ROM that includes the plurality of lessons. In one option, a first lesson may be downloaded and the remainder of the lessons of the plurality may then be sent on a CD-ROM. This option allows immediate access to the first lesson, while ensuring delivery of the remaining lessons by the time that they are needed.

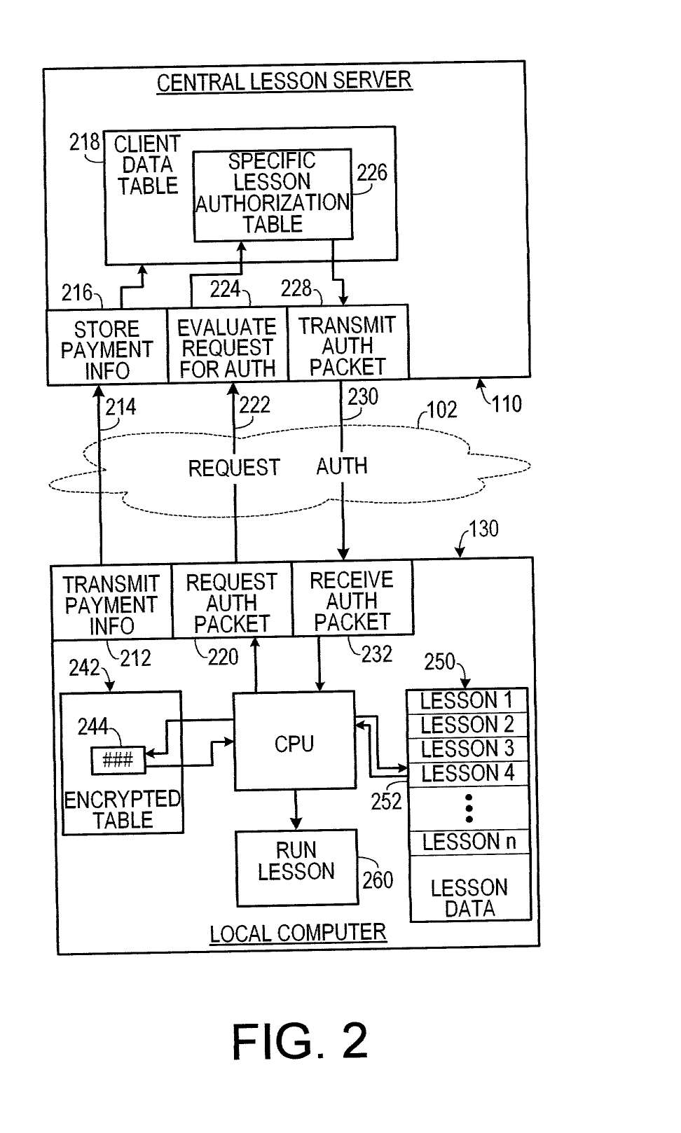

As shown in FIG. 2, prior to beginning a series of lessons, a user at the local computer 130 transmits payment information 212 in the form of a data packet 214 sent via the global computer network 102. Typically, this would be done by accessing a web site controlled by the central lesson server 110 and entering identifying and credit card information relating to the user. The payment information is stored 216 in a client database 218.

Initially, a plurality of lessons 250 are sent to the user. Typically, they are sent on a CD-ROM and then transferred into the hard drive of the local computer 130. The lessons are not immediately usable in the format in which they are supplied on the CD-ROM, but require additional data from the central lesson server 110 to activate each lesson.

When the user desires to access a specific lesson (e.g., lesson 252), the local computer 130 generates a request 220 in the form of a data packet that is transmitted 222 via the global computer network 102 and that identifies the desired lesson and the user to the central lesson server 110. This is also typically done by accessing a web site under the control of the central lesson server 110. The central lesson server 110 receives and evaluates 224 the request. The evaluation involves accessing a lesson authorization table 226 as part of the client database 218 to determine if the user has paid for the requested lesson. If the user has paid for the lesson, then the central lesson server 110 generates 228 a lesson-specific authorization data packet and transmits 230 the authorization data packet to the local computer 130 via the global computer network 102. This operation, in one exemplary embodiment, might be done using an “Active-X” control, which is a plug-in employed by the Microsoft® Internet Explorer browser. Using an Active-X control, the authorization data packet is written to a selected location 244 of an encrypted table 242 that is resident on the local computer 130, as a result of receipt of a control data packet. The encrypted table may be created by the plug-in the first time that a lesson is accessed.

When the user desires to run the specific lesson 252, the local computer 130 accesses the encrypted table 242 to determine if the selected location 244 contains the expected data. If so, a run routine 260 executes the lesson 252. Thus, the system is able to use the global computer network 102 for distribution without having to download large files for every lesson, giving the user a rich interactive environment.

In another embodiment, each lesson of the plurality of lessons 250 is encrypted with a different key. The authorizing data packet for a specific lesson would comprise the key for that specific lesson.

While the above example discloses an embodiment that may be used with educational software, it is understood that the scope of the invention applies to any system used to unlock specific units of data that are part of a plurality of units of data that are stored on a local computer from a central server.

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. A method of activating data at a local computer, comprising the steps of:
a. transmitting via a global computer network, from the local computer to a central server, a request data packet that includes information that identifies a user and that identifies a specific unit of data that the user desires to activate, the specific unit of data belonging to a predefined plurality of units of data that are stored local to the local computer;
b. receiving a unit-specific activating data packet from the central server at the local computer; and
c. executing a routine at the local computer that uses the unit-specific activating data packet to activate the specific unit of data.

2. The method of claim 1, wherein the receiving step comprises receiving a control data packet used to create an encrypted file on the local computer that includes data necessary to execute a run routine that causes the specific unit of data to be activated.

3. The method of claim 1, wherein the receiving step comprises receiving a control data packet used to modify a previously-created encrypted file on the local computer that includes data necessary to execute a run routine that causes the specific unit of data to be activated.

4. The method of claim 1, wherein the receiving step comprises receiving an encryption key that may be used in decrypting the specific unit of data.

5. The method of claim 1, wherein the executing step comprises running a plug-in on the local computer.

6. The method of claim 1, wherein specific unit of data comprises a computer-run lesson and wherein the predefined plurality of units of data comprise a suite of computer-run lessons.

7. A method of activating a computer-based lesson on a local computer, comprising the steps of:
a. transmitting via a global computer network, from the local computer to a central server, a request data packet that includes information that identifies a user and a specific lesson that the user desires to activate, the specific lesson belonging to a predefined plurality of lessons that are stored on the local computer;
b. receiving a lesson-specific activating data packet from the central server at the local computer;
c. executing a routine at the local computer that uses the lesson-specific activating data packet to activate the specific lesson; and
d. running the specific lesson on the local computer.

8. The method of claim 7, wherein the receiving step comprises receiving a control data packet used to create an encrypted file on the local computer that includes data necessary to execute a run routine that causes the specific unit of data to be activated.

9. The method of claim 7, wherein the receiving step comprises receiving a control data packet used to modify a previously-created encrypted file on the local computer that includes data necessary to execute a run routine that causes the specific unit of data to be activated.

10. The method of claim 7, wherein the receiving step comprises receiving an encryption key that may be used in decrypting the specific unit of data.

11. The method of claim 7, wherein the executing step comprises running a plug-in on the local computer.

12. A method of activating computer-readable data from a central server, comprising the steps of:
a. receiving at the central server a request data packet from a local computer via a global computer network, the request data packet including information that identifies a user and that identifies a specific unit of data that the user desires to activate, the specific unit of data belonging to a predefined plurality of units of data that are stored local to the local computer;
b. executing a verification routine that determines if the user is authorized to activate the specific unit of data; and
c. if the user is authorized to activate the specific unit of data, then transmitting a unit-specific activating data packet from the central server to the local computer, wherein the activating data packet allows the local computer to activate the specific unit of data.

13. The method of claim 12, wherein the verification routine determines if the user has paid for the specific unit of data.

14. The method of claim 12, wherein the transmitting step comprises transmitting a control data packet used to create an encrypted file on the local computer that includes data necessary to execute a run routine that causes the specific unit of data to be activated.

15. The method of claim 14, further comprising the step of executing the run routine by activating a plug-in that is resident on the local computer.

16. The method of claim 12, wherein the transmitting step comprises transmitting a control data packet used to modify a previously-created encrypted file on the local computer that includes data necessary to execute a run routine that causes the specific unit of data to be activated.

17. The method of claim 16, further comprising the step of executing the run routine by activating a plug-in that is resident on the local computer.
